(19) United States
(12) Patent Application Publication
(10) Pub. No.: US 2005/0041103 A1
(43) Pub. Date: Feb. 24, 2005

(54) Image processing method, image processing apparatus and image processing program

(75) Inventor: Naoto Kinjo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/919,314

(22) Filed: Aug. 17, 2004

(30) Foreign Application Priority Data
Aug. 18, 2003 (JP) 2003-294597

(51) Int. Cl. H04N 5/225

(52) U.S. Cl. 348/207.1

(57) ABSTRACT

Using an image processing program, a personal computer identifies objects photographed in individual images, on the basis of additional data appended to image data of those images. The image data and the additional data are obtained and written on a memory by a digital camera, and transferred to the personal computer. When the user selects a part to correct in an image, plural levels of categories are displayed on a monitor in accordance with the object corresponding to the selected part. The user selects a category from among the displayed categories, and designates contents and parameters of image correction. Then, any parts of the image which correspond to those objects included in the selected category are automatically corrected in the designated manner. If necessary, also those parts of other relating images which correspond to the objects included in the selected category are automatically corrected in the designated manner.

### FIELD OF THE INVENTION

The present invention relates to an image processing method for correcting color and other factors to improve quality of images photographed by digital cameras or the like, and an image processing apparatus and an image processing program for that method.

### BACKGROUND ARTS

As the digital cameras are being widely used, an increasing number of users begin to process the photographed images on their personal computers for the sake of correcting the color or the quality of the images.

In order for those users to process the images with ease, Japanese Laid-open Patent Application Hei 11-275351 suggests an image processing method for processing a series of image frames which are related to each other, wherein a particular part of a first one of the series of image frames is designated to be corrected, and image characteristic values of the particular part are memorized before the correction. After this part is corrected, the contents of the correction are memorized. Then, those parts having similar image characteristic values to the memorized image characteristic values are extracted from other image frames of the series, as similar part to the particular part. Then the same image correction is automatically done on these similar parts, as on the particular part of the first image frame. According to this prior art, image data of similar parts of a number of relating image frames are processed with ease at a high efficiency.

Japanese Laid-open Patent Application No. 2001-238177 discloses an image processing method for processing each image frame in accordance with what kind of photographic scene the image frame may be classified into. In this prior art, camera data such as the position of photography are obtained or entered at the photography of each subject and, if necessary, data relating to the kind of photographic scene is entered. Then, the kind of photographic scene is estimated with reference to at least one of the camera data and the relating data alone or in combination with the image data. How to process the image is predetermined in accordance with the photographic scenes. Because the image processing is optimized for the photographic scene of the image to be corrected, high quality images can be obtained.

According to the former prior art, however, because the similar parts are extracted with reference to the image characteristic values, some of the extracted parts can be unrelated to the designated particular part of the first image frame. Moreover, if there are not any similar parts in the following image frames, the user must carry out different image processing from one image frame to another. In that case, the processing efficiency would be lower than conventional.

Since the latter prior art automatically defines the parameters for the image processing, the processed images do not always agree with the user's memory or impression at the photography, or the user's taste or intention.

### SUMMARY OF THE INVENTION

In view of the foregoing, a primary object of the present invention is to provide an image processing method that ensures designating image portions to be corrected and enables correcting images with high efficiency, and an image processing apparatus and an image processing program for that method.

Another object of the present invention is to provide an image processing method that can reproduce images as reflecting the user's intention, and an image processing apparatus and an image processing program for that method.

To achieve the above and other objects, an image processing method of the present invention comprises the steps of identifying objects corresponding to parts of a photographed image; determining plural levels of categories in accordance with one of the objects which corresponds to a selected part to correct in the image; selecting a category from among the plural levels of categories; and carrying out same image correction on the selected part and on those parts of the image and relating images to the image, which correspond to objects included in the selected category.

It is preferable to make it possible to choose whether to carry out the image correction on the relating images or not.

According to a preferred embodiment, IC tags storing identification data of the objects are appended to the objects, and the objects are identified by reading out the identification data from the IC tags.

According to another preferred embodiment, the objects are identified by retrieving identification data of the objects from a data base on the basis of photographic data appended to the image.

An image processing apparatus of the present invention comprises an identifying device for identifying objects corresponding to parts of photographed images; a determining device for determining plural levels of categories in accordance with one of the objects which corresponds to a selected part to correct in one of the images; a selecting device for selecting a category from among the plural levels of categories; and a correction device for carrying out same image correction on the selected part and on those parts of the one image and relating images to the one image, which correspond to objects included in the selected category.

According to a preferred embodiment, the image processing apparatus further comprises a device of allowing to choose whether to carry out the image correction on the relating images or not.

In a preferred embodiment, the identifying device identifies photographed objects by reading out identification data of the objects from IC tags appended to the objects.

In another preferred embodiment, the identifying device identifies the photographed objects by retrieving identification data of the objects from a data base on the basis of photographic data appended to the image.

An image processing program of the present invention comprises steps of identifying objects photographed in an image; determining plural levels of categories in accordance with an object that corresponds to a part selected to correct in the image; extracting those parts from the image, which correspond to objects included in a category selected from among the plurality of levels of categories; correcting the extracted parts in accordance with designated parameters; identifying those objects which are included in the selected category with respect to relating images to the image; and correcting corresponding parts of the relating images to the identified objects in the same way as the extracted parts of the image.

According to the image processing method, apparatus and program of the present invention, image parts to correct are automatically extracted with high accuracy, so that the efficiency of image correction is improved. Because the category of objects to correct and the parameters of image correction are selected or designated by the user, the image correction will reflect the user's intention and liking.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is an explanatory diagram illustrating an image processing apparatus embodying the method of the present invention;

FIG. 2 is a block diagram illustrating the electric structure of a digital camera as a component of the image processing apparatus of the invention;

FIG. 3 is a block diagram illustrating the electric structure of a personal computer as a component of the image processing apparatus of the invention;

FIG. 4 is an explanatory diagram illustrating an image window displayed initially at the activation of an image processing program of the present invention;

FIG. 5 is an explanatory diagram illustrating a window for designating a category of objects to correct;

FIG. 6 is an explanatory diagram illustrating a window for designating contents of image correction; and

FIG. 7 is a flowchart illustrating the overall sequence of the image processing program.

### DESCRIPTION OF THE PREFERRED EMBODIMENTS

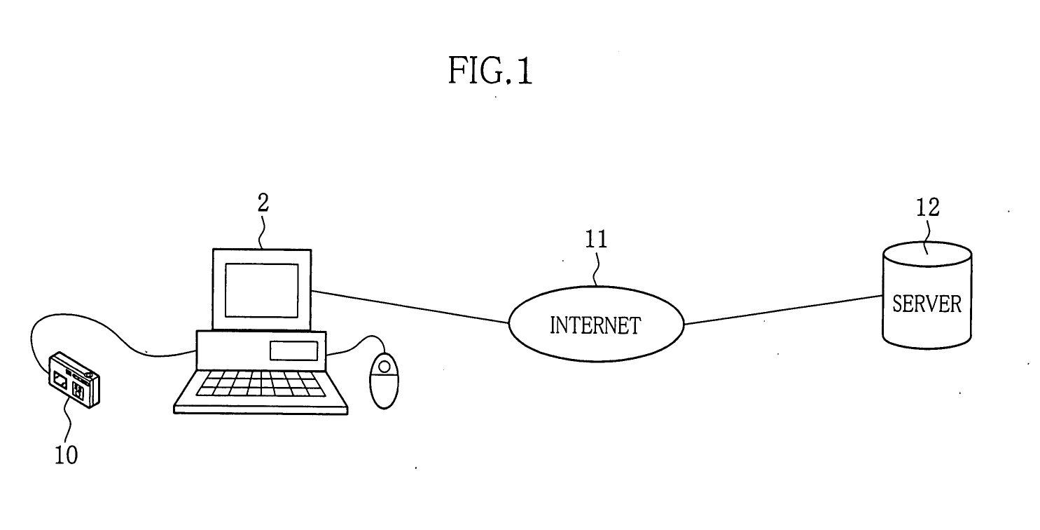

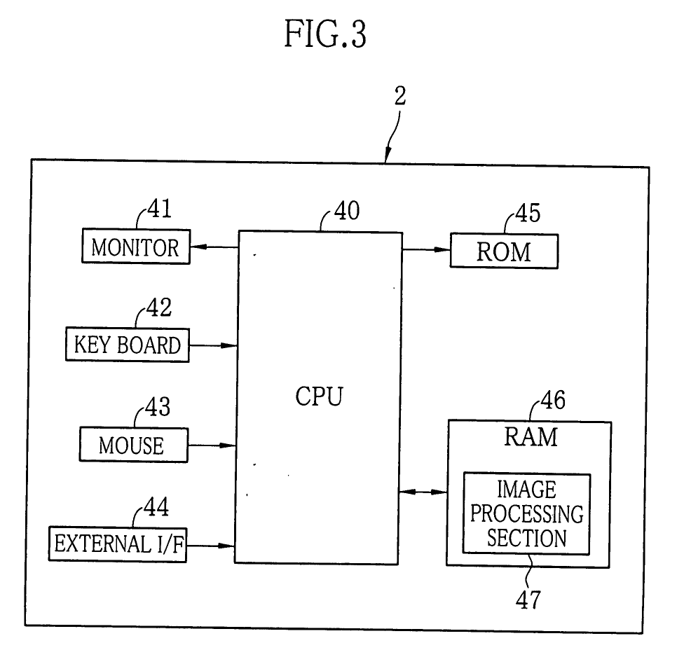

In FIG. 1, a personal computer 2 has an image processing program 47 (see FIG. 3) of the present invention installed therein, and a digital camera 10 is connected to the personal computer 2. The personal computer 2 is also connected to a server 12 through the Internet 11.

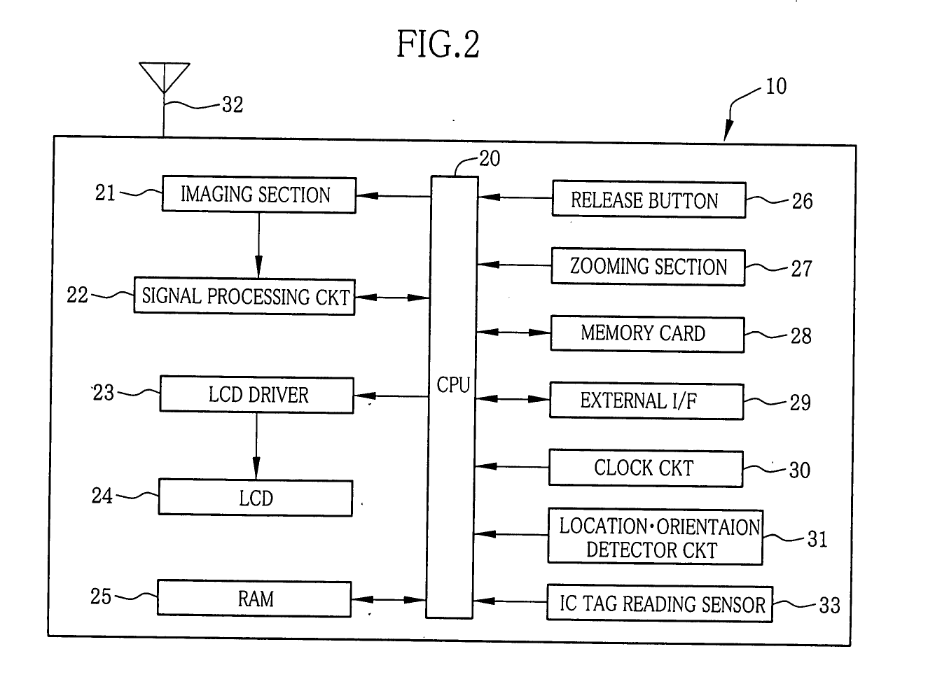

In FIG. 2, showing the electric structure of the digital camera 10, a CPU 20 supervises and controls respective parts of the digital camera 10. An imaging section 21 is constituted of a not-shown photographic lens and a not-shown CCD, wherein an optical image of a subject formed through the photographic lens is picked up as an image signal through the CCD. A signal processing circuit 22 amplifies the image signal up to a predetermined level, and then converts the image signal into digital image data. The digital image data is subjected to various kinds of image processing, such as white balance adjustment and gamma-correction.

The digital image data obtained through the signal processing circuit 22 is used for driving an LCD driver to display a slew of images on a liquid crystal display (LCD) 24. A random access memory (RAM) 25 stores the image data after being processed through the signal processing circuit 22.

The CPU 20 outputs control signals to the respective parts in response to some operations on a release button 26 and a zooming section 27. When the release button 26 is operated, the image data presently stored in the RAM 25 is compressed through the signal processing circuit 22, and the compressed data is written on a memory card 28. An external interface 29 controls signal communication between the digital camera 10 and external apparatuses such as the personal computer 2.

A clock circuit 30 counts clock data of the digital camera 10, and outputs the clock data to the CPU 20 during the photography. A location-and-direction detector circuit 31 detects the present location and orientation of the digital camera 10 on the basis of signals from a GPS antenna 32 that receives electromagnetic waves from satellite. The location is detected as coordinates. An IC tag sensor 33 reads out ID data of an object that is photographed in a part of the image, for example, a person, furniture, cloths or accessories, from an IC tag that is appended to the object.

When the image data is written on the memory card 28, additional data are written in association with the image data. The additional data include zoom ratio data or an amount of operation on the zooming section 27, date-of-photograph detected by the clock circuit 30, data of photo location and orientation that are detected by the location and orientation detector circuit 31, and the information detected by the IC tag reading sensor 33.

As shown in FIG. 3, the personal computer 2 is constituted of a CPU 40, a monitor 41, a keyboard 42, a mouse 43, an external interface 44, a ROM 45 and a RAM 46. The RAM 46 is installed with the image processing program 47.

The server 12 stores a 3D (three-dimensional) map data base used for identifying the object on the basis of the zoom ratio data and the photo location and orientation data, a data base showing a relationship between ID data read out from the IC tags and a variety of objects of photography, a data base recording plural levels of categories classifying the variety of objects, an image data base storing a number of images, and other data bases.

The personal computer 2 accesses the server 12 through the Internet 11, to carry out image processing with reference to the data bases stored in the server 12 in the following manner. Alternatively, the data bases may be contained in the image processing program 47. In that case, it is unnecessary for the personal computer 2 to access the server 12.

On the basis of the additional data written in association with the image data on the memory card 28, the image processing program 47 identifies objects that correspond to respective parts of the individual image, i.e. the objects photographed in the individual image, for example, in a method as disclosed in the above mentioned Japanese Laid-open Patent Application No. 2001-238177.

For example, if the photographed subject is a mountain, the mountain is identified by use of the zoom ratio data and the photo location and orientation data as detected by the location and orientation detector circuit 31 with reference to the 3D map data base. Specifically, the photographed subject is compared with those objects which exit inside a given angle of view on a map that is defined depending upon the zoom ratio data and the photo location and orientation data. That is, on the basis of the zoom ratio data and the photo location and orientation data, a 3D computer graphic (CG) image is produced from the 3D map data base in a conventional CG making method, and the CG image is compared with the actually photographed image by use of pattern matching.

In this example, pattern matching is carried out between a ridge line of the mountain of the photographed image, which is determined by edge-extraction based on color differences between pixels of the photographed image, and mountain ridges of the CG image produced from the 3D map data base. While shifting pixels of the CG image two-dimensionally, a point where the ridge line of the photographed mountain coincides with that of the CG image the most is determined. Based on the zoom ratio, photo location and orientation at that point, the name of the photographed mountain and its location are retrieved from the 3D map data base.

If the photograph is made in a town, it is possible to identify individual constructions in the same way as above. If an object is not determined to be other than a person, conventional face extraction is carried out on the image part corresponding to that object. If an image of a face is extracted, the image part is determined to be a person.

The mouse 43 is operated for selecting an object to correct from among plural objects photographed in an image, wherein these objects are identified by the image processing program 47. The mouse 43 is also operated for choosing a category as a subject for the image correction from several levels of categories defined by the selected object, and for designating contents of the image correction.

The image processing program 47 processes image data of those image parts which correspond not only to the selected object but also to those objects included in the selected category, in order to carry out the designated image correction. The designated image correction is effected not only on the image of which the object to correct is selected, but also on other images relating to this image, such as images stored in the same folder, those photographed on the same day, a series of movie images including the selected image and the like.

As examples of the contents of the image correction, density, color tinge, color saturation, gradation, sharpness, smoothness and size may be referred to, as shown in FIG. 6. If the selected object is a person, the contents of the image correction may include complexion of the face, color of the hair, soft-focusing and red-eye correction.

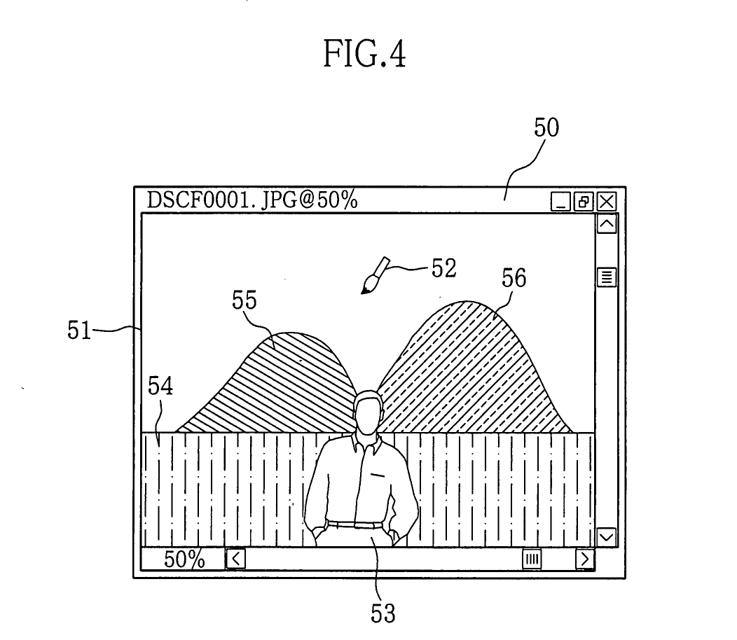

When the image processing program 47 is activated, the monitor 41 displays an image window 50 as shown for example in FIG. 4. In the image window 50, an image 51 read from the digital camera 10 and a cursor 52 moving in cooperation with the mouse 43 are displayed. The image 50 displayed initially may be a head one of a number of images stored in a folder, a head frame of movie images, a representative image or an image designated by the user.

The image 51 shown in FIG. 4 is composed of a person 53, grass 54, a first mountain 55 and a second mountain 56. These objects are identified in the way as described above. One of these objects is selected by clicking the mouse 43 while putting the cursor 52 on the object to select. It is alternatively possible to select an object by inputting the proper name or noun of that object as character data through the keyboard 42 or as voice data through a not-shown microphone of the CPU 20.

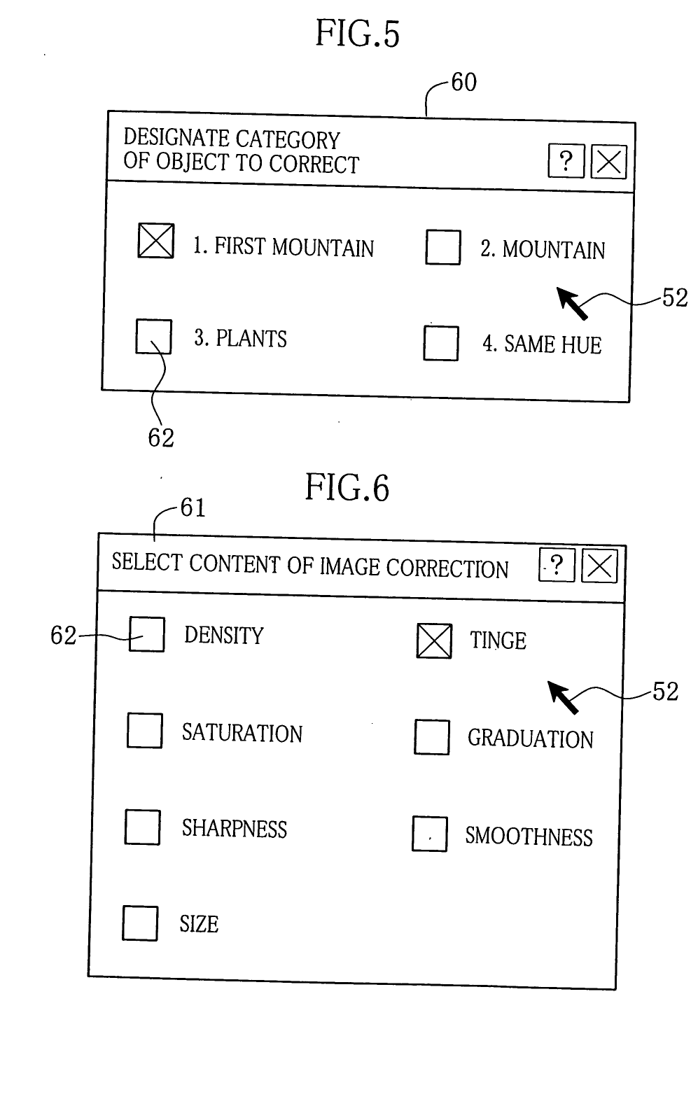

When the first mountain 55 is selected as the object to correct, a category designation window 60 and a content of image correction designation window 61 are displayed on the monitor 41, as shown for example in FIGS. 5 and 6. The category designation window 60 displays four categories directed to the first mountain 55: 1. proper name of the first mountain, 2. mountain, 3. plants, 4. hue. To designate the category and the content of image correction, the mouse 43 is clicked while putting the cursor 52 sequentially on respective checkboxes 62 for the items to select.

In the present embodiment, the numbers of the categories as listed in the same category designation window 60 increase in the order toward upper level, wherein the upper-level category covers the wider range of objects. For example, when the person 53 is selected as the object to correct, person, sexuality, age and people are displayed as categories in this order toward the upper number in the category designation window 60. When a piece of furniture is selected as the object to correct, individual articles and materials are displayed as categories. As categories for the cloths and accessories, individual articles, type, density, hue and so on are displayed. In addition, the sun or the shade, or the season may be included in available categories.

If the category “1. FIRST MOUNTAIN” is selected in the category designation window 60, image correction is carried out on a part of the image 51 which correspond to the first mountain 55. If there are relating images to the image 51, image parts of these images which correspond to the first mountain are subjected to the image correction. If the category “2. MOUNTAIN” is selected in the category designation window 60, image correction is carried out on those parts of the image 51 which correspond to the first and second mountains 55 and 56, and those image parts which correspond to mountains are corrected in the relating images. If the category “3. PLANTS” is selected in the category designation window 60, image correction is carried out on those parts of the image 51 which correspond to the first and second mountains 55 and 56 and the grass 54, and image parts corresponding to mountains and grass are corrected in the relating images. If the category “4. SAME HUE” is selected in the category designation window 60, image correction is carried out on those parts of the image 51 and the relating images which correspond to such objects as having the same hue as the first mountain. For example, if the person 53 wears a green shirt, the image of the green shirt is also corrected in the same way as the mountains 55 and 56 and the grass 54.

The contents of the image correction are determined by parameters for the correction that are selected by the user through the keyboard 42 and the mouse 43.

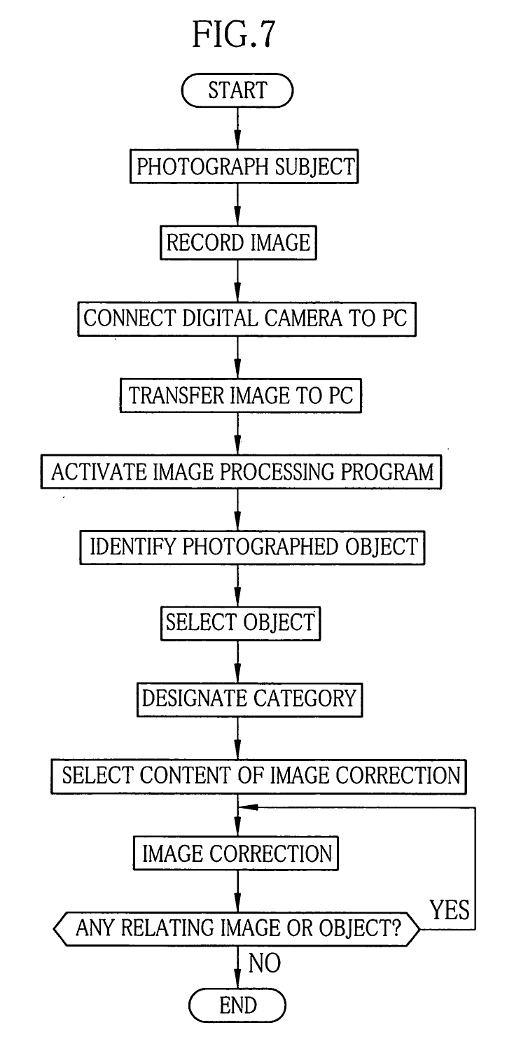

Now the operation of the present embodiment will be described with reference to the flowchart shown in FIG. 7.

Images are photographed by the digital camera 10, so that image data of the photographed images are written on the memory card 28 along with additional data including the zoom ratio data, the date-of-photograph data, the location and orientation of the photograph, and identification data of photographed objects.

After the photography, the digital camera 10 is connected to the personal computer 2, to output the image data and the additional data to the personal computer 2. When the image processing program 47 is activated, the image window 50 is displayed on the monitor 41, and the image processing program 47 identifies the objects of the displayed image 51 on the basis of the additional data appended to the image data of the image 51.

When one of the objects of the displayed image 51 is selected by the user through the mouse 43, the monitor 41 displays the category designation window 60 and the content of image correction designation window 61. The user selects the category for the image correction from among several options displayed in the category designation window 60, and also designates the contents of the image correction in the content of image correction designation window 61. Then, the image data of those parts of the image 51 which correspond to the objects included in the selected category are processed for the image correction determined by the image processing program 47. At that time, the user selects parameters for the image correction through the keyboard 42 and the mouse 43, so that the image is corrected in accordance with the image correction parameters selected to reflect the user's intention and liking.

If there are any images relating to the image 51 on which the image correction is carried out, the image correction is carried out on corresponding parts of the relating images to those objects which are included in the designated category while using the same parameters as used for the image 51. In this way, the image processing program 47 continues the image correction till all of the relating images are processed, or till all of the image parts which correspond to the objects included in the designated category are processed.

According to the above described configuration, the user has only to designate the category of objects to correct, then corresponding image parts to the objects included in the designated category are automatically processed for image correction. In addition, it is possible for the users to preset the contents of the image correction in accordance with their own memories, impressions and taste.

It is to be noted that the category designation may be done after the selection of contents of image correction. It is also possible to designate the category without choosing any object. It is preferable to make those image parts distinctive on the image window 50, which correspond to the objects determined to be the object of the correction, for example, by winking those parts.

It is possible to provide the server 12 with map data that indicate locations of public constructions, such as electric wires, utility poles and pylons, so that public constructions in the photographed images may be identified with reference to the map data. Then, the user may erase or blur the electric wires or utility poles in all relating images simultaneously when the user selects merely an electric wire or a utility pole and erases or blurs it. In the same way, it is possible to erase or blur a particular object such as road signs or buildings. This erasing treatment may be applicable to those objects which damage the beauty of photographed images, such as trash cans or wastepaper on the street. Because the position of the trash can or wastepaper within the image is not determined, a three-dimensional position of that object in the image is estimated, and the estimated position is compared to the data base stored in the server 12, so as to identify that object.

It is desirable to merge an appropriate background image in each part from where the original object, e.g. a trash can, is erased. The appropriate background image may be retrieved from the image data base stored in the server 12. Alternatively, the erased part may be treated with the pixel interpolation by use of pixels in the periphery of the erased part. If there is not any appropriate background in the data base, it is preferable to produce a background image using a conventional CG technique, and merge the CG image in the erased part.

In order to reflect the user's taste, it is possible to collect data relating to the user's taste by displaying plural image samples on the monitor 41, which are substantially identical but corrected with gradually varied parameters. From among these samples, the user is required to select the most preferable one, and the results of the user's choice are accumulated for a certain period. The data relating to the user's taste may be derived from the accumulated results, and stored as a data base in the server 12, so that the data may be read out at the activation of the image processing program 47. This configuration enables automatic retrieval of such image correction parameters as congenial to the user's taste. So it saves the user time and labor for adjusting image correction parameters.

On processing a flash-photographed image containing any person, it is possible to enlarge the face of a person on the monitor 41 in order to check if the person suffers the red-eye phenomenon. If yes, the red-eye phenomenon is checked as to other persons of the same image and those persons of other images who exit in corresponding positions of individual images to the position of the person determined to suffer the red-eye. Then the red-eye compensation is carried out on those persons who are determined to suffer the red-eye. Because the object of the red-eye compensation is limited to the persons whose positions are determined, the image processing is still more speeded.

Although the above embodiment automatically correct corresponding parts of the relating images to the corrected objects of the initially displayed image, it is possible to allow the user to select between correcting the corresponding objects of the relating images or not. Thereby, if the user knows that the relating images do not contain the same object as the object to correct, process of extracting the same object from the relating images, which is unnecessary in this case, will be skipped to improve the efficiently.

The present invention is effective not only for correcting those images which are photographed by the digital camera 10 but also for correcting images downloaded through the Internet 11, so far as their image data are accompanied with additional data for identifying individual objects.

In the above embodiment, the personal computer 2 is referred to as the image processing apparatus, the present invention is applicable to image scanners or printer-processor that are installed in photo-shops.

Thus, the present invention is not to be limited to the above embodiment but, on the contrary, various modifications will be possible within the scope and sprit of the present invention as specified in the appended claims.

1. An image processing method comprising steps of:
identifying objects corresponding to parts of a photographed image;
determining plural levels of categories in accordance with one of said objects which corresponds to a selected part to correct in said image;
selecting a category from among said plural levels of categories; and
carrying out same image correction on said selected part and those parts of said image and relating images to said image, which correspond to objects included in said selected category.

2. An image processing method as claimed in claim 1, wherein it is possible to choose whether to carry out said image correction on said relating images or not.

3. An image processing method as claimed in claim 1, wherein IC tags storing identification data of said objects are appended to said objects, and said objects are identified by reading out said identification data from said IC tags.

4. An image processing method as claimed in claim 1, wherein said objects are identified by retrieving identification data of said objects from a data base on the basis of photographic data appended to said image.

5. An image processing method comprising steps of:
A. identifying objects photographed in digital photographic images;
B. selecting a part to correct in an image;
C. selecting a category from among plural levels of categories determined in accordance with an object corresponding to said selected part to correct;
D. extracting those parts from said image, which correspond to objects included in said selected category;
E. correcting said extracted parts in accordance with designated parameters;
F. extracting from relating images to said image, corresponding parts to said objects included in said selected category; and
G. correcting said corresponding parts of said relating images in the same way as said extracted parts of said image.

6. An image processing method as claimed in claim 5, further comprising, before the step F, a step of choosing between correcting said relating images or not, wherein the steps F and G are omitted if it is not chosen to correct said relating images.

7. An image processing method as claimed in claim 5, wherein the step A comprises steps of:
appending IC tags to some objects, said IC tags being written with identification data of respective objects;
reading out said identification data from at least one of said IC tags which exits in a photographic field at each photography, to store said identification data in association with image data obtained at each photography; and
identifying photographed objects with reference to said stored identification data.

8. An image processing method as claimed in claim 5, wherein the step A comprises steps of retrieving identification data of photographed objects from a data base on the basis of photographic data appended to image data of individual images, and identifying said photographed objects with reference to said retrieved identification data.

9. An image processing method as claimed in claim 8, wherein said photographic data include at least one of location and orientation of photography, date and time of photography, and a zoom ratio.

10. An image processing apparatus comprising:
an identifying device for identifying objects corresponding to parts of photographed images;
a determining device for determining plural levels of categories in accordance with one of said objects which corresponds to a selected part to correct in one of said images;
a selecting device for selecting a category from among said plural levels of categories; and
a correction device for carrying out same image correction on said selected part and those parts of said one image and images relating to said one image, which correspond to objects included in said selected category.

11. An image processing apparatus as claimed in claim 10, further comprising a device of allowing to choose whether to carry out said image correction on said relating images or not.

12. An image processing apparatus as claimed in claim 10, wherein said identifying device identifies photographed objects by reading out identification data of said objects from IC tags appended to said objects.

13. An image processing apparatus as claimed in claim 10, wherein said identifying device identifies said photographed objects by retrieving identification data of said objects from a data base on the basis of photographic data appended to said image.

14. An image processing program comprising steps of:
A. identifying objects photographed in an image;
B. determining plural levels of categories in accordance with an object that corresponds to a part selected to correct in said image;
C. extracting those parts from said image, which correspond to objects included in a category selected from among said plurality of levels of categories;
D. correcting said extracted parts in accordance with designated parameters;
E. identifying those objects which are included in said selected category with respect to relating images to said image; and
F. correcting corresponding parts of said relating images to said identified objects in the same way as said extracted parts of said image.

15. An image processing program as claimed in claim 14, further comprising a step of choosing between correcting said relating images or not, wherein if it is not chosen to correct said relating images, said program does not proceed to the steps E and F.

16. An image processing program as claimed in claim 14, wherein photographed objects are identified with reference to identification data of said objects that are read out from IC tags appended to said objects.

17. An image processing program as claimed in claim 14, wherein photographed objects are identified with reference to identification data of said objects, which are retrieved from a data base on the basis of photographic data appended to respective image.
